(19) United States
(12) Patent Application Publication
(10) Pub. No.: US 2023/0366697 A1
(43) Pub. Date: Nov. 16, 2023

(54) Sound source modeling of drones and the synthesis in indoor environments towards acoustics-based indoor localization

(71) Applicant: Technion Research & Development Foundation Limited, Haifa (IL)

(72) Inventors: Tom Hirshberg, Haifa (IL); Alexander Bronstein, Haifa (IL)

(73) Assignee: Technion Research & Development Foundation Limited, Haifa (IL)

(21) Appl. No.: 18/316,195

(22) Filed: May 11, 2023

Related U.S. Application Data
(60) Provisional application No. 63/364,598, filed on May 12, 2022.

(51) Int. Cl. G01C 21/00

(52) U.S. Cl. CPC G01C 21/383; G01C 21/3841; G01S 5/18

(57) ABSTRACT

A method for localization of a drone within a building, the method may include (a) detecting, by an acoustic detection unit of the drone, sounds generated by a propulsion unit of the drone while the drone is located within the building; and (b) determining, by a processing unit of the drone, the location of the drone within the building, based on the sounds and on building acoustic information regarding sounds detected at different portions of the building.

### CROSS REFERENCE

This application claims priority from U.S. provisional patent Ser. No. 63/364,598 filing date May 12 2022—which is incorporated herein by reference.

The patent or application file contains at least one drawing executed in color. Copies of this patent or patent application publication with color drawings will be provided by the Office upon request and payment of the necessary fee.

### BACKGROUND

Unmanned aerial vehicles (UAVs), commonly known as drones, are becoming popular and powerful tools for commercial and civil applications, evolving beyond their military origins. Growing to be autonomous vehicles, drones have to autonomously navigate and interact with unknown environments, both outdoors and, more challenging, indoors. One of the basic capabilities allowing this is simultaneous localization and mapping (SLAM), i.e., constructing or updating a map of the environment while simultaneously keeping track of the robot's location within. Today's most effective SLAM algorithms are vision-based, often assisted by GPS and active range sensors. Even though vision-based SLAM algorithms are robust, they suffer from limited field of view and poor performance in reduced visibility conditions. This has motivated the interest in auditory sensing-based SLAM techniques. To date, the field of acoustic SLAM is much less developed compared to its visual counterpart, with only a few studies examining mapping and localization based on sound sources.

Previous works explored the task of navigation by combining visual and auditory sensing. Other works used bio-inspired and data-driven approaches to map indoor environments. Recent work also showed a geometrical room mapping based on the first-order echoes from an omni-directional speaker to a microphones array mounted on a drone. These works use an external sound source, such as a loudspeaker, for localization and mapping, which can be heavy to mount on a small drone.

Prior art reference include:
a. R C Smith, P Cheeseman, On the representation and estimation of spatial uncertainty. The international journal Robotics Res. 5, 56-68 (1986).
b. C Evers, P A Naylor, Acoustic slam. IEEE/ACM Transactions on Audio, Speech, Lang. Process. 26, 1484-1498 (2018).
c. C Chen, et al., Learning to set waypoints for audio-visual navigation. arXiv preprint arXiv:2008.09622 1, 6 (2020).
d. I Eliakim, Z Cohen, G Kosa, Y Yovel, A fully autonomous terrestrial bat-like acoustic robot. PLoS computational biology 14, e1006406 (2018).
e. J S Hu, C Y Chan, C K Wang, M T Lee, C Y Kuo, Simultaneous localization of a mobile robot and multiple sound sources using a microphone array. Adv. Robotics 25, 135-152 (2011).
f. G Hwang, S Kim, H M Bae, Bat-g net: Bat-inspired high-resolution 3d image reconstruction using ultrasonic echoes. Adv. Neural Inf. Process. Syst. 32 (2019).
g. J H Christensen, S Hornauer, X Y Stella, Batvision: Learning to see 3d spatial layout with two ears in 2020 IEEE International Conference on Robotics and Automation (ICRA). (IEEE), pp. 1581-1587 312 (2020).
h. M Boutin, G Kemper, A drone can hear the shape of a room. SIAM J. on Appl. Algebr. Geom. 4, 123-140 (2020).
i. S A Rizzi, A K Sahai, Auralization of air vehicle noise for community noise assessment. CEAS Aeronaut. J. 10, 313-334 (2019).
j. J R Hardwick, Synthesis of rotorcraft noise from flyover data. M.S. Thesis, Dep. Mech. Eng. Virginia Tech, Blacksburg, V A (2014).
k. A W Christian, D D Boyd, N S Zawodny, S A Rizzi, Auralization of tonal rotor noise components of a quadcopter flyover, Technical report (2015).
l. K Heutschi, B Ott, T Nussbaumer, P Wellig, Synthesis of real world drone signals based on lab recordings. Acta Acustica 4, 24 (2020).
m. M Strauss, P Mordel, V Miguet, A Deleforge, Dregon: Dataset and methods for uav-embedded sound source localization in 2018 IEEE/RSJ International Conference on Intelligent Robots and Systems (IROS). (IEEE), pp. 1-8 (2018). 320
n. R Scheibler, E Bezzam, I Dokmanic, Pyroomacoustics: A python package for audio room simulation and array processing algorithms in 2018 IEEE International Conference on Acoustics, Speech and Signal Processing (ICASSP). (IEEE), pp. 351-355 (2018).
o. J Allen, D Berkley, Image method for efficiently simulating small-room acoustics. J. Acoust. Soc. Am. 65, 943-950 (1976).
p. J Borish, Extension of the image model to arbitrary polyhedra. J. Acoust. Soc. Am. 75, 1827-1836 (1984).
q. N Intaratep, W N Alexander, W J Devenport, S M Grace, A Dropkin, Experimental study of quadcopter acoustics and performance at static thrust conditions in 22nd AIAA/CEAS Aeroacoustics 325 Conference. p. 2873 (2016).
r. J Bradbury, et al., JAX: composable transformations of Python+NumPy programs (2018).
s. D C Liu, J Nocedal, On the limited memory bfgs method for large scale optimization. Math. programming 45, 503-528 (1989).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a measurement system; and

FIG. 2 is an example of inverse and forward scheme;

FIGS. 3A and 3B illustrate an example of real (measured) pressures and simulated pressures generated by a single rotor;

FIG. 4 illustrates an example of pressure fields in free sample of more than a single rotor;

FIGS. 5A and 5B illustrate an example of correlation localization experiment results;

FIG. 6 illustrates an example of a method;

FIG. 7 illustrates an example of a method;

FIG. 8 illustrates a movement of a drone within a building; and

FIGS. 9-15 illustrate examples of pressure patterns at different points of time.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There is provided a method for in-door navigation.

Additionally or alternatively, there is provided a method for mapping an in-door environment.

There may be provided a combination of mapping an in-door environment and using the outcome of the mapping for in-door navigation.

There is provided a method that uses the drone propulsion system as a powerful acoustic source, and actively shape it for the needs of localization and mapping.

To model the self-sound of multi-rotor UAVs, acoustics analysis and high-fidelity computational fluid dynamic (CFD) methods can be used. However, these methods require significant computational resources. Therefore, data-driven and analytical methods are commonly used to model the sound source, enabling the generation of a pressure-time history of the moving rotors along a time-varying shaft position.

Data-driven methods for drones sound modeling were inspired by the sound source modeling of helicopters. These methods studied the sound emitted by each rotor individually and simulated the combination of several rotors. Other data-driven approaches modeled the pressure-field created by a set of four rotors, achieving realistic interactions between the spinning rotors, but losing the ability to control the angular velocity of each individual rotor. Current publicly available auditory datasets are few, and consist of flyover data only, making the recordings vulnerable to aircraft movements and external environmental disturbances, such as wind. Therefore, the inventors recorded a new dataset of a spinning rotor in a semi-anechoic room for modeling the self-sound of rotors in free-space.

In indoor environments, simulating the echoes and interactions with walls increases the computational complexity of CFD-based acoustics simulations. An alternative consists of simple geometric acoustics simulations that require low computational resources but are somewhat inferior in terms of accuracy. Geometric approaches are based on the image source model (ISM), in which source reflections on walls are replaced by imaginary sources, whose echoes are combined to build a room impulse response (RIR).

There is provided a data-driven approach for sound source modeling of a drone, by modeling each rotor individually and combining the effects of multi-rotors using superposition. To simulate the sound of a drone in a room, the inventors developed a differential geometric simulation based on, enabling to solve inverse problems such as acoustic-based indoor localization. It is also shown how modulating the emission angle of rotors without significant changes to the drone's thrust can improve indoor localization.

To model the self-sound of drones, acoustics analysis and high-fidelity computational fluid dynamic methods can be used. However, these methods require significant computational resources. Therefore, data-driven and analytical methods are commonly used to model the sound source, enabling the generation of a pressure-time history of the moving rotors along a time varying shaft position. It is suggested using a simple and low computational data-driven method for modeling the sound source of a drone in free space and indoors.

A suggested model relies on a new high quality ground truth dataset of a spinning rotor in free space. Aiming beyond the sound source modeling, the model simplicity allows solving inverse problems such as indoor self-localization. As a proof of concept, it was shown by the inventors how to improve the localization accuracy based on simple phase modulations.

Data-driven methods for simulating the aeroacoustics effects of spinning rotors are commonly used due to their low-computational needs. Although previous works are based on modeling the pressure level on a hemisphere around the rotors, they are not modeling the sound source itself. A simple and low-computational data-driven method IS provided for modeling the sound source of a drone in free space and indoors. The model relies on a new high-quality ground-truth dataset of a spinning rotor in free space. Aiming beyond the sound source modeling, its simplicity allows solving inverse problems such as indoor self-localization. The results show that simple phase modulations, which do not change the drone's thrust significantly, improve the invertibility of indoor self-localization.

Free-Space Modeling of a Spinning Rotor

Simulating the aeroacoustics effects of moving objects using high fidelity CFD simulations are extremely computationally expensive. Therefore, semi-empiric and geometric-based methods that allow more efficient computations are commonly used as an inexpensive alternative. By keeping the simulation efficient and simple, only stationary point sound sources and receivers can be used. The self-sound of a rotor is complex and consists of three sound types: tonal, motor, and the broadband components. The current application may focus on the tonal sound only due to its characteristics. The tonal sound is the loudest component and consists of the lowest frequencies forming the drone's self-sound. It is a harmonic sinusoidal wave and cyclic symmetric around the rotor's origin. Its lowest frequency Omega (ω) is determined by the blade pass frequency (BPF), and depends on the angular velocity of the rotor ω(n) and its number of blades n by ω=n*ω(n).

The sound source parameters are modeled in a data-driven approach using ground truth sound recording of a spinning rotor in a semi-anechoic room. In these recordings, a circular 2-D array of omni-directional microphones recorded the pressure field in sync with the rotor's instantaneous shaft position, for several constant angular velocities of the motor. The array was placed at several distances from the rotor's origin in each experiment. Since shifting the signals recorded at each microphone is equivalent to adding phase to the rotor for constant angular velocities, only a single microphone can be used to create the ground truth recordings for the entire pressure field. This enables to simulate the entire pressure field, even at radial positions where no microphones were placed, and also to reduce the errors arising from differences between microphones.

Rotating the rotor in constant velocities, enabled also to average the tonal sound with respect to the rotor's instantaneous shaft position, which reduced the environmental noise. So, and by a reason of symmetry to time, the independent time variable used in our model is the rotor's angular position alpha (α). Due to the linearity of the system and its cyclic symmetry characteristic, the pressure level at each point in the rotor's field is comprised by the harmonics of ω, and affected only by delay and gain changes. Therefore, and given the simulation's limitations, the suggested model the sound source of a spinning rotor as a stationary circular phased array of point sources denoted by S.

In this modeling a polar coordinate system is being used. Each source sϵS emits a harmonic sinusoidal signal X{s}(α) as a function of α, with amplitudes A{s,k} and phases φ{s,k} for each harmonic k:

X{s}(∝)=Σₖ₌₁^{K}A{s,k}COS(nkα+φ{s,k}) (1)

Where K is the highest modeled harmonic of the tonal sound.

The pressure level at position (r,θ) around the rotor is determined by:

\hat{p}(r,θ,α)=Σ_{SϵR}a_{(r,θ)}(s,α)*X{s}(α) (2)

Where α_{(r,θ)}(s, α) is the impulse response function between a microphone placed at (r,θ) to the sources V in free-space.

Modeling the sound source is expressed as an optimization problem, using the ground-truth measurements. The set of all trainable parameters is denoted ∂={A{s,k}∇s ∈S,k ∈{0 . . . K}}.

The optimization problem is defined by

argmin_{∂}Σ_{(r,θ)ϵR}∥\hat{p}(r,θ,α)−p(r,θ,α) (3)

With respect to pairs of simulated \hat{p}(r, θ) and ground truth p(r, θ) recordings from microphones placed at R on the rotor's plane. The parameters θ to this problem are defined by the amplitudes and phases of each source and harmonic as described in equation (1).

Acoustics Environment Simulation

The acoustics indoor simulation is based on pyRoomAcoustics, and extended with JAX to allow differentiation through the simulator. The direct path from source to microphone is computed together with the reflected paths from the walls, based on the image source model (ISM) that replaces sources reflections on walls by imaginary sources. Then, the room impulse response (RIR) is computed from the corresponding echoes, and the signals emitted by the sources are convolved with it to create the signals received by the microphones. Hence, the pressure level at position (r, θ) in indoor environment up to image order $N$ is determined by

p(r,θ,α)=Σᵢ₌₀^{N}Σ_{sϵV}_{ⁱ}_{(r,θ)}(a_{(r,θ)}(s,α)*X{s}(α)) (4)

Where Vⁱ(r, θ) is the set of images of order i that are visible from a microphone positioned at (r, θ). The atmospheric attenuation affects the direct and reflected paths and can be controlled within the simulation, allowing various environmental conditions. The absorption of the walls adds to the attenuation and can be controlled as well.

Multi-Rotor Configurations

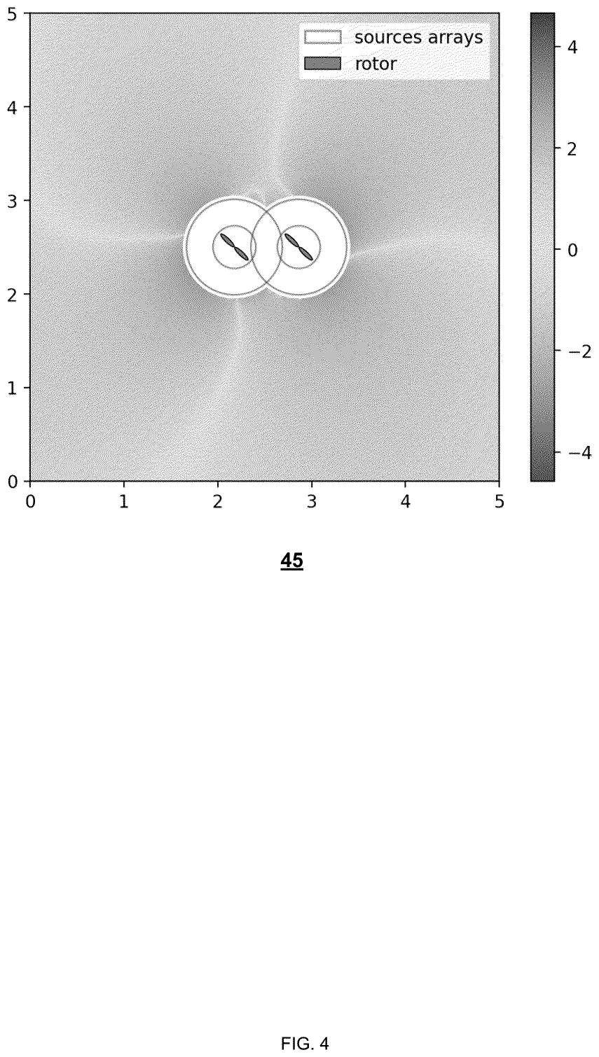

To generate the sound source of a drone, four models of the rotor are coupled by superposition. Modeling the sound source of each rotor individually allows to set and modulate the emission angle of each rotor separately by phase modulations. It enables to generate the clockwise and anti-clockwise pairing system of rotors, making a more realistic simulation. FIG. 4 shows the pressure field 45 created indoor by a set of four rotors.

Invertibility of the Indoor Sound Source Model

Differentiation of the indoor simulation allows to solve inverse problems such as indoor localization, rotor's sound shaping, aircraft modeling, etc. Solving these problems requires good invertibility of the sound source model. The invertibility can be measured by the correlation coefficient between samples, aiming at the best non-correlative set. As part of the inverse problems, indoor self-localization is a basic capability allowing drones to be autonomous. As an invertibility measurement to this problem, the correlation coefficient is computed between recordings at all points on a Cartesian coordinates grid (X,Y) in a room to a reference point (X_0,Y_0)∈(X,Y).

We suggest that a good non-correlative recordings can be achieved without significant changes to the drone's thrust using phase modulations to the sound source model, by adjusting Equations (1) and (4) to

\tilde{X}{s}(∝)=Σₖ₌₁^{K}A{s,k}COS(nkα+φ{s,k}+(α,m) (5)

P( [symbol] )=Σᵢ₌₀^{N}Σ_{sϵV}_{ⁱ}_{(r,θ)}(a_{(x,y)}(s,α)*X{s}(α)) (6)

Equations (5) and (6) are measured on the Cartesian grid (X,Y) where \tilde{φ}(α, m) denotes the modulated phase and depends on the rotor rotation number $m$. To reduce the computation time of high order images, the orders can be limited by their contribution to the recordings' gain. By comparing constant phase shifts with a simple phase modulation, it is suggested that the later achieves better results in improving the invertibility of the localization problem.

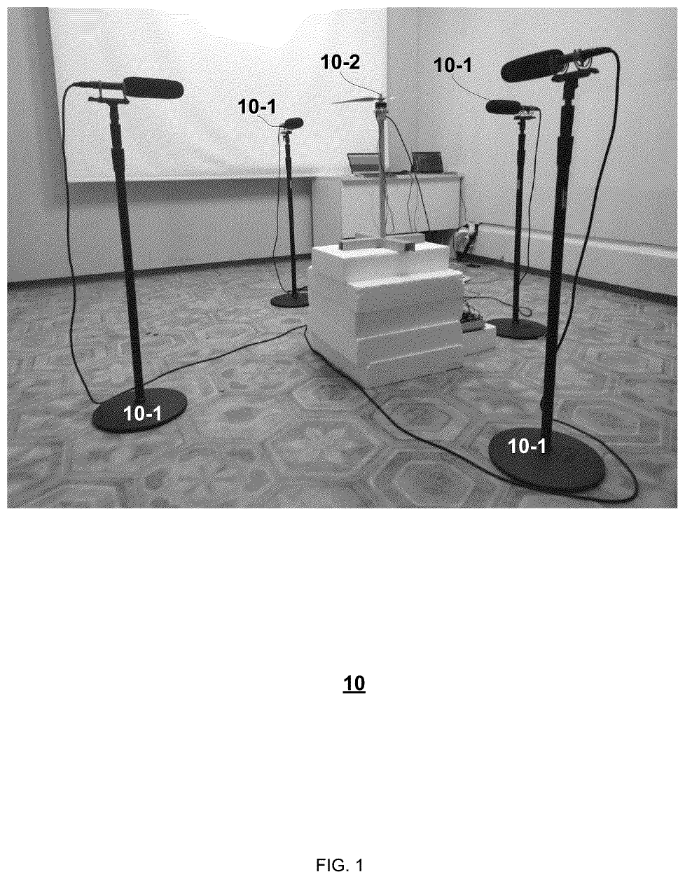

FIG. 1 illustrates an example of a measurement system 10 that includes multiple microphones 10-1 that surround a rotor 10-2.

Results

An Individual Rotor in Free-Space

To generate the pressure field of an individual rotor in free-space, Equation (3) is solved with the recorded ground truth data using L-BFGS algorithm.

To imitate the rotor, a circular point-sources array was placed in the simulation, where each source emitted the sound signal as in Equation (1). The microphones were placed in similar positions to the ground truth microphones in free-space.

Placing two sources arrays around the rotor's origin achieved good results in solving Equation (3).

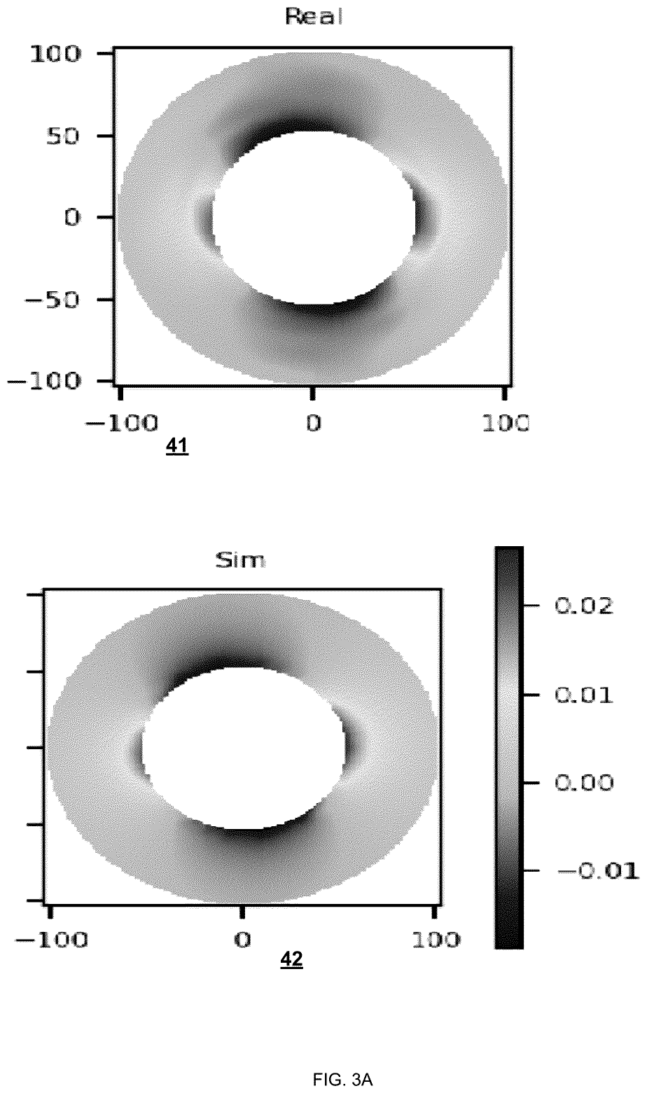

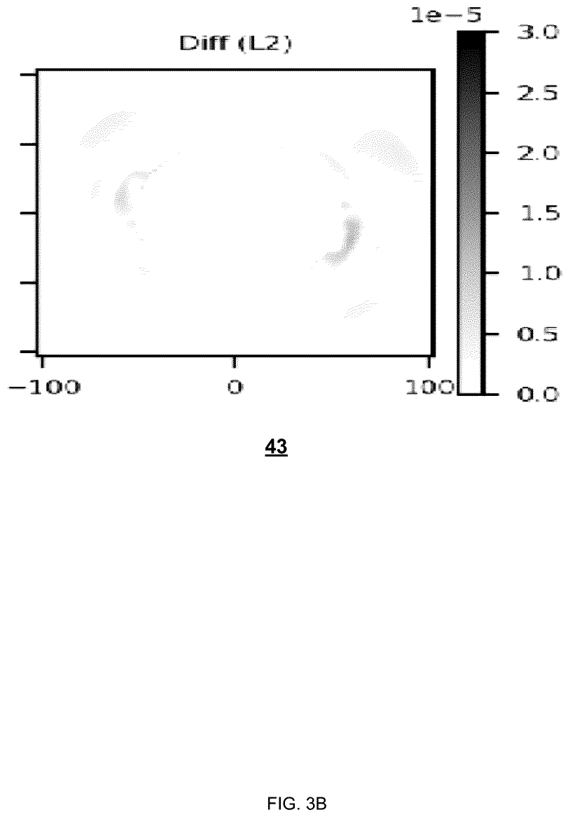

FIGS. 3A and 3B show the similarities and differences (L2 calculated differences 43) between the ground truth pressure-field 41 and the optimized simulated field 42. It shows that the high and low pressure-level blobs around the rotor are similar, as well as their spreading.

A Set of Four Rotors in a Room

To form the sound source of a drone, four optimized models of the rotor's sound source were coupled by superposition. Having a sound source model for each rotor individually allows to set and modulate the emission angle of each rotor separately, enabling to create more realistic scenarios and the ability to examine the effects of different phases between rotors. However, mutual effects between rotors cannot be modeled due to the simplicity of the simulation. FIG. 4 shows the pressure field of a set of four rotors in a room.

Acoustics-Based Indoor Localization and the Contribution of Phase Modulation

In this experiment it is shown how active shaping to the rotors' sound improves the invertibility of the self-localization problem. Two rotors were surrounded by a circular array of microphones on a grid in a square-shaped room. The phase of one rotor was modulated slightly by

$$φ ( ∝ ) = \frac{π}{2} * \frac{∝}{( Ns * 2 π )}$$

along Ns spins of the rotor.

The highest image order was calculated according to Equation (6).

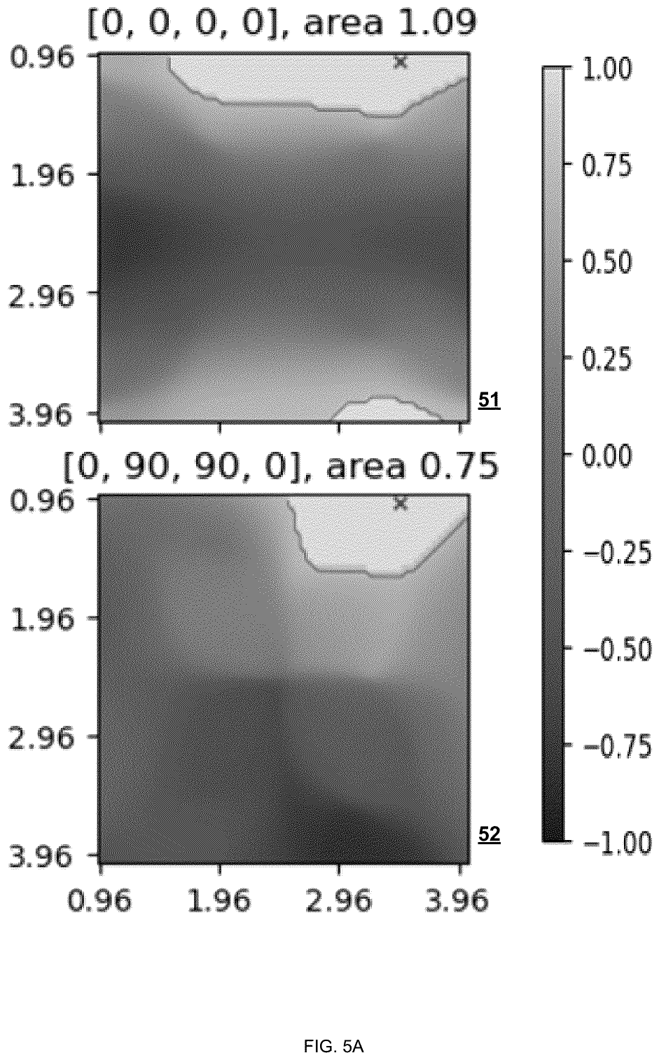

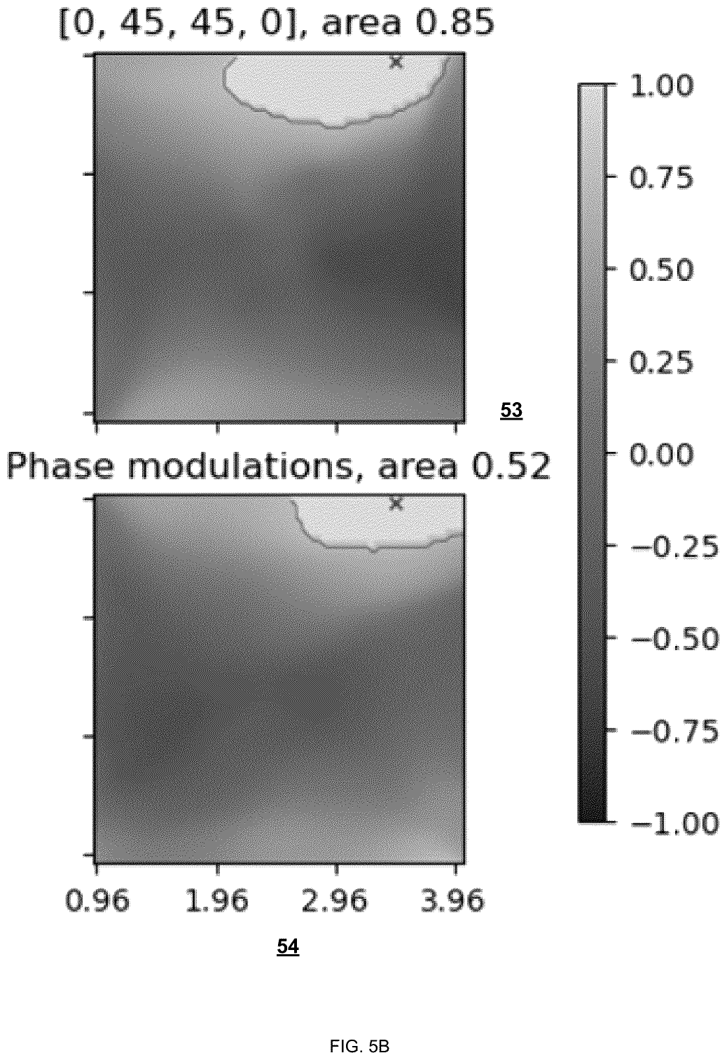

To measure the problem's invertibility, the correlation coefficient between recordings at each position on the grid to reference positions were calculated, for several windows in the length of a single rotor's revolution. FIG. 5 shows a comparison of the invertibility measurement at a reference position between phase modulation, no modulation, and constant phase shifts where

$$φ ( ∝ ) ∈ \{ \frac{π}{4} , \frac{π}{2} \} .$$

The results show lower correlation for phase modulation, i.e. better invertibility.

FIGS. 5A and 5B illustrate examples of correlation localization experiment results 51, 52, 53 and 54. The results are taking at different phase relationships between the four rotors of the drone—{0, 0, 0, 0} phase relationship between the four rotors, {0, 90, 90, 0} phase relationship between the four rotors, {0, 45, 45, 0} phase relationship between the four rotors, and phase modulations—indicating changes over time of the phase relationship between the four rotors.

### Discussion

We presented a method for data-driven modeling of the sound source of a drone in free space and indoors. The modeling relies on a new dataset of ground-truth recordings. The suggested method is generic to any drone's structure, rotor, and the number of rotors, by having a high-quality dataset. Since our model is low-computational and requires simple resources, it can be applied to inverse problems involving the sound of drones in free space and indoors, such as indoor self-localization. This localization problem was solved and it was shown how to improve its invertibility with a simple phase modulation and no significant changes to the drone's thrust. Future work includes optimizing the phase modulation to achieve better invertibility of the localization problem and modeling the interactions between rotors for a more realistic drone model. It is concluded that various other related problem in the field such as mapping, rotor sound shaping, and SLAM can benefit from the suggested solution.

Data Preprocessing

Using low-pass filter to isolate the tonal component, denoising by averaging the signals, constructing the entire free space from a single channel.

The pre-processing of the real recordings may include a Butterworth-broadband filtering of the audio channels, to isolate the tonal component from other noise components. The encoder readings are filtered by a Butterworth-lowpass filter to overcome electrical noise, and are synchronized by the instantaneous shaft position and a home-position indicator.

Indoor Simulation and Localization

Reducing the computational complexity by limiting the images orders taken into account.

We define the contribution criterion by the differences between successive orders of sources images that forming RIRs

$${argmax}_{N} \{ ‖ \frac{{\sum }_{s ∈ {Vr}^{N}} ( {a}_{r} ( s , α ) )}{{\sum }_{i = 0}^{N} {\sum }_{s ∈ Vr} i ( {a}_{r} ( s , α ) )} ‖ \} = < ϵ , ∀ : ‖ r - o ‖ < R \}$$

With a given threshold ϵ, and for microphones placed up to radius $R$ from the rotors' origin o.

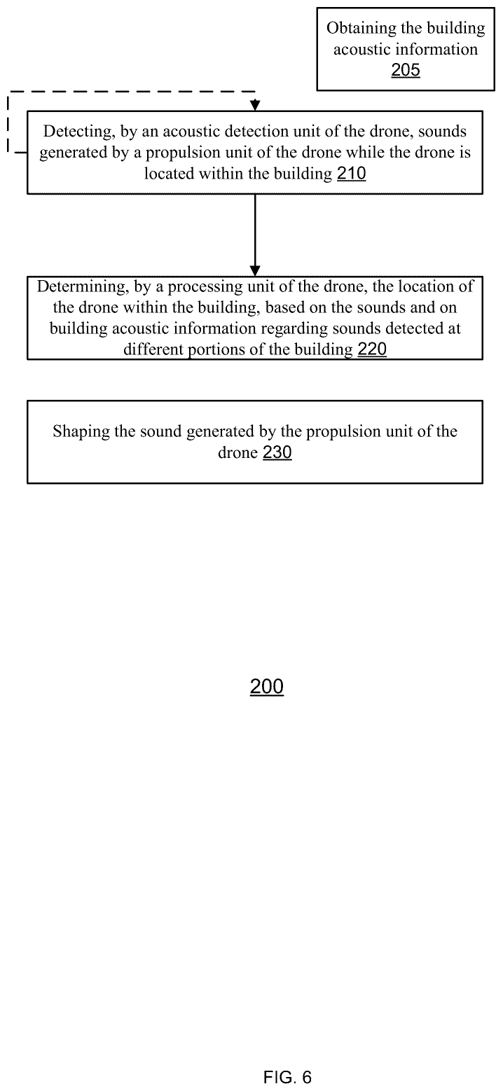

FIG. 6 illustrates an example of method 200 for localization of a drone within a building.

Method 200 may include step 210 of detecting, by an acoustic detection unit of the drone, sounds generated by a propulsion unit of the drone while the drone is located within the building.

Step 210 may be followed by step 220 of determining, by a processing unit of the drone, the location of the drone within the building, based on the sounds and on building acoustic information regarding sounds detected at different portions of the building.

Method 200 may include step 205 of obtaining the building acoustic information.

Step 205 may include generating at least a part of the building acoustic information by the processing unit of the drone, and/or receiving at least a part of the building acoustic information.

The generating of the at least part of the building acoustic information may include mapping at least a part of the building. The mapping may include obtaining acoustic signatures that represent different parts of the building.

Step 210 may include detecting sounds that are generated by the propulsion unit within a blade pass frequency (BPF). These sound may be regarded as one or more acoustic signatures, may be regarded as part of one or more acoustic signatures, may be further processed to provide one or more acoustic signatures, and the like.

Step 220 of determining the location of the drone may include applying a low power consuming location determining process. The location determining process is referred to as a low power consuming as it concentrates mostly on signals within the blade pass frequency (and not on the entire acoustic range), as it may be executed applying any of the approximations and/or any calculation mentioned above.

For example—the low power consuming location determination process ignores sounds outside the BPF.

The low power consuming location determining process is based on the building acoustic information that was generated using simulations and/or was generated using measurements.

The simulations may model sounds directly detected by an acoustic detection unit of a simulated drone and also simulate reflected sounds reflected from a simulated indoor environment.

The location of a drone may be determined by following a single iteration of step 210.

Alternatively, the location of the drome may be determined by performing multiple iterations of step 210.

It should be noted that the sound generated by the propulsion unit may change from time to time. For example—by shaping that sound.

Method 200 may include step 230 of shaping the sound generated by the propulsion unit of the drone.

The shaping may include controlling at least one parameter of the sound generated by the propulsion unit of the drone. The shaping may include changing the pressure pattern of the sound generated by the propulsion unit of the drone. The pressure pattern may be omnidirectional or directional, may include one or more interference patterns, and the like.

Using different interference patterns may provide more information about the in-door environment of the drone.

The drone may include rotors and the shaping may include introducing phase difference between the rotations of two or more of the rotors, assuming the same rotational speed.

The shaping—may be executed between one iteration of step 210 to another.

The shaping may be executed based on the outcome of an iteration of step 220, may be executed a predetermined time per location of the drone, may be repeated until a predefined location certainty is obtained, and the like.

The shaping may change while the drone is positioned at the same location and/or may be changed while the drone moves within the building.

A changing of the noise generated by the propulsion unit of the drone may stop when the drone successfully completes the determining the location of the drone.

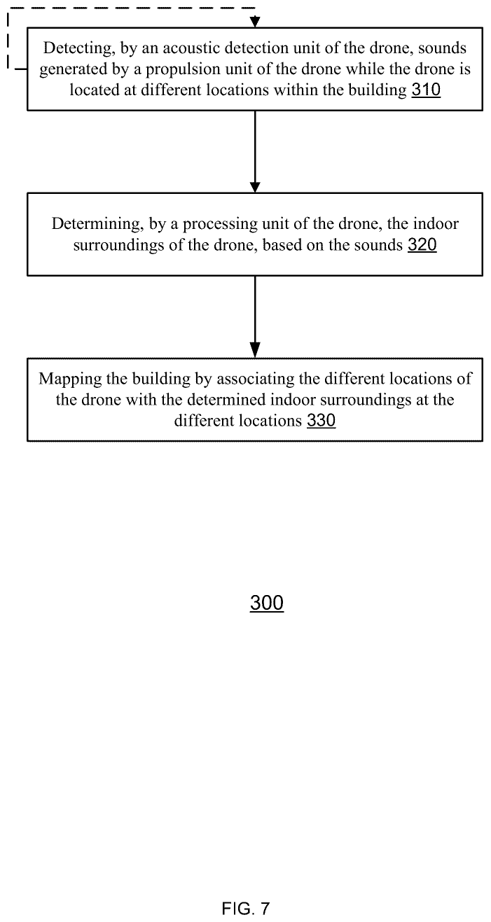

FIG. 7 illustrates an example of method 300 of mapping.

Method 300 may include step 310 of detecting, by an acoustic detection unit of the drone, sounds generated by a propulsion unit of the drone while the drone is located at different locations within the building.

Step 310 may be followed by step 320 of determining, by a processing unit of the drone, the indoor surroundings of the drone, based on the sounds. Step 320 may include determining the indoor surrounding of the drone when the drone is located at the different locations within the building.

Step 320 may be followed by step 330 of mapping the building by associating the different locations of the drone with the determined indoor surroundings at the different locations.

Step 330 may provide building acoustic information—that may include a relationship between acoustic signatures and different locations within the building.

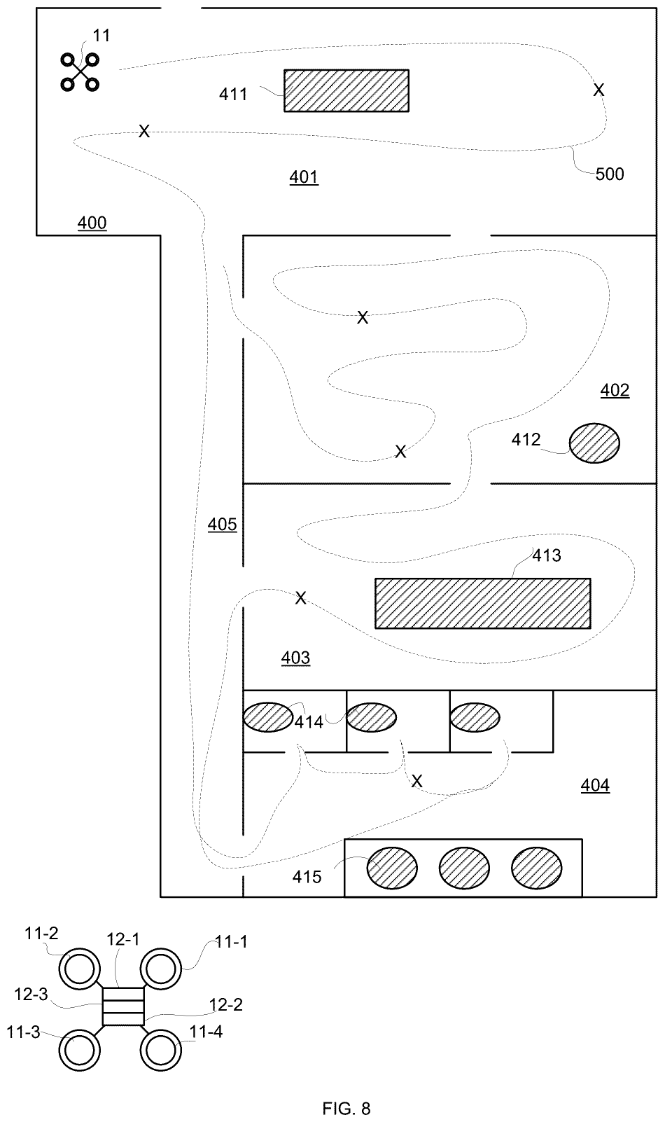

FIG. 8 illustrates an example of a movement of a drone within a building 400. The drone is illustrates as including a propulsion unit that include four propulsion sub-units 11-1, 11-2, 11-3 and 11-4 0 each propulsion sub-unit includes a rotor and a motor that rotates the rotor, one or more processing circuit 12-1, an acoustic detection unit 12-2, and a controller 12-3. Other components such as power supply, landing gear, and the like are not shown for simplicity of explanation.

The building has rooms 401, 402, 403 and 404 and a corridor 405, and there are various objects (such as one or more tables, toilets, chairs, sinks, and the like) denoted 411, 412, 413 and 414.

The drone passes through the building following path 500. The path 500 may include multiple locations—some of them are denoted X.

During indoor localization, the drone may determine its location by applying method 200. The drone may apply shaping and/or may use one or more pressure patterns at different locations. During indoor mapping the drone may determine the acoustic signals at different locations along the path. If the locations of the drone during the mapping are known (for example from another source) then the interior of building 400 can be acoustically mapped.

What amount to the surroundings of the drone (may be used during mapping) may be regarded as the different rooms, there may be different surroundings within a single room, and the like.

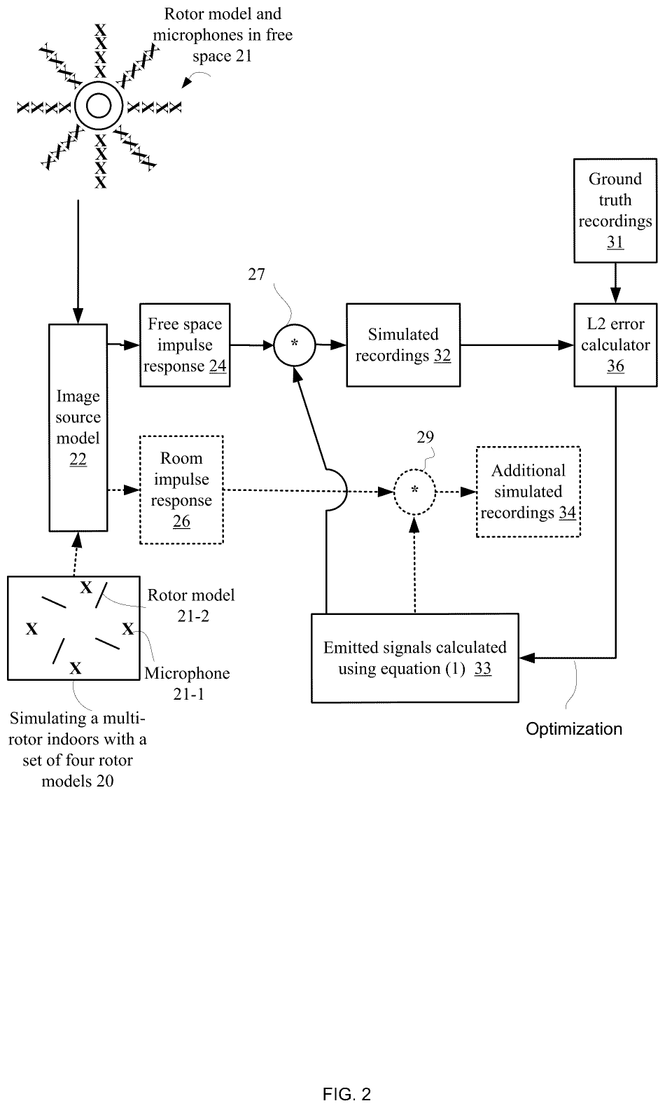

FIG. 2 illustrates an example of modelling the sound source of a rotor in free space, and the simulation of sound recordings of a quadrotor indoors.

The modelling of the rotor in free space includes using point sound sources arrays, and then optimizing the parameters of the emitted signals using real-world ground truth recordings. Especially—the modelling of the rotor in free space is executed by using a rotor model and microphones in free space 21 followed by image source model 22 that feeds a free space impulse response 23 that feeds a first multiplier 27. The first multiplier 27 is also fed by emitted signals generated by unit 33 and are calculated by equation (1). The first multiplier 27 sends the first product to provide simulated recordings 32 that are fed by an error calculator unit 36 (such as squared error loss {L2} error calculator 36). The L2 error calculator calculates the error based in ground truth recordings 31 and the simulated recordings 32 to provide an error signal. The error signal is fed to unit 33 a d the emitted signals generated by unit 33 are optimized. Other error calculation methods may be used.

The simulation of sound recordings of a quadrotor indoors includes (α) simulating a quadrotor using four modeled rotors (denoted motor models 21-1) that are surrounded by an array of microphones (denoted 21-2) such a four indoor microphones, (b) feeding the outcome of the simulation 20 to the room impulse response 26, (c) feeding the output of the room impulse response 26 to a second multiplier 29, (d) multiplying, by the second multiplier, the output of the room impulse response by emitted signals generated by unit 33 and are calculated by equation (1)—to provide a second product, (e) sending the second product to provide additional simulated recordings 34.

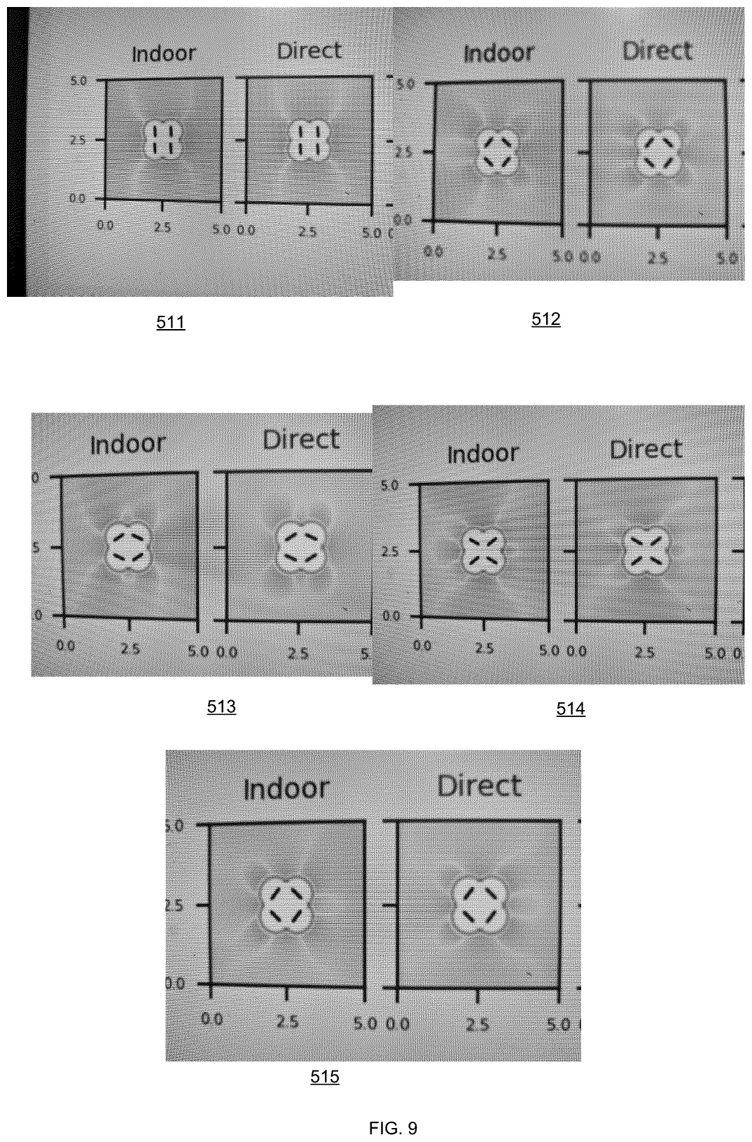

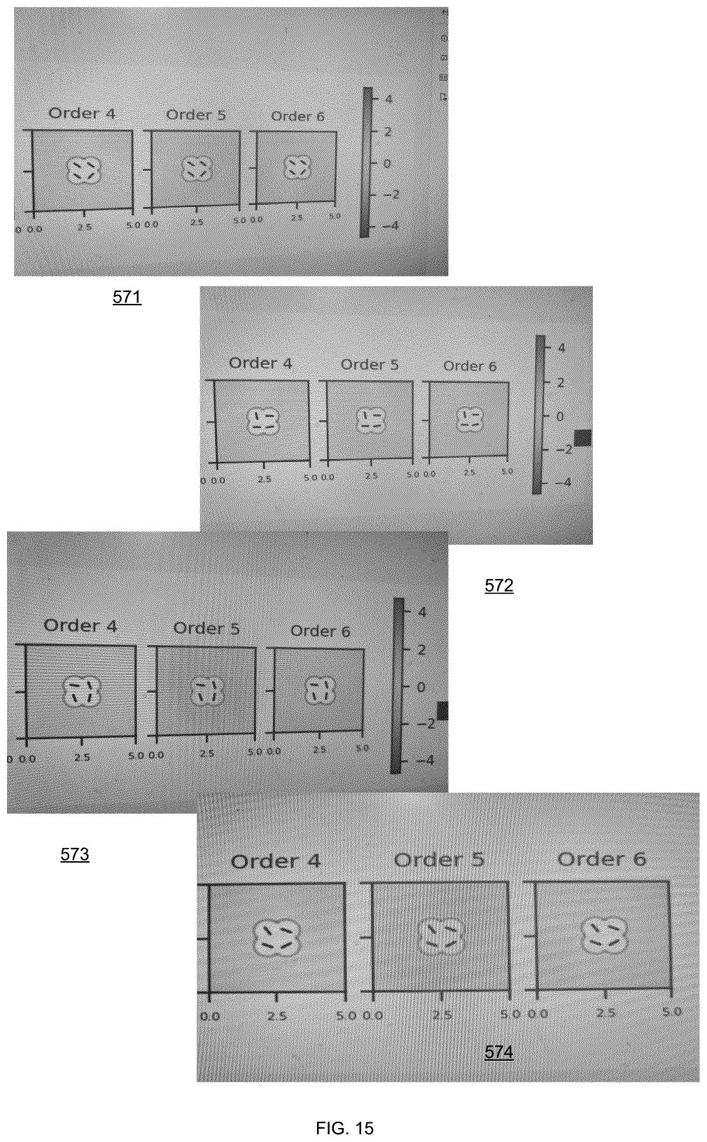

FIGS. 9-15 illustrate examples of pressure patterns at different points of time:
a. Pressure field indoor (denoted “Indoor”)—direct path detected sounds in an indoor environment.
b. Free space pressure field (denoted “Direct”)—free space detected sounds not taking into account echoes from walls.
c. Pressure field generated by multiple orders of echoes—such as Order 1, Order 2, Order 3, Order 4, Order 5 and order 6 echoes.

FIG. 9 illustrates examples of Indoor and Direct pressure patterns 511, 512, 513, 514 and 515—of a drone that includes two pairs of counter rotating rotors.

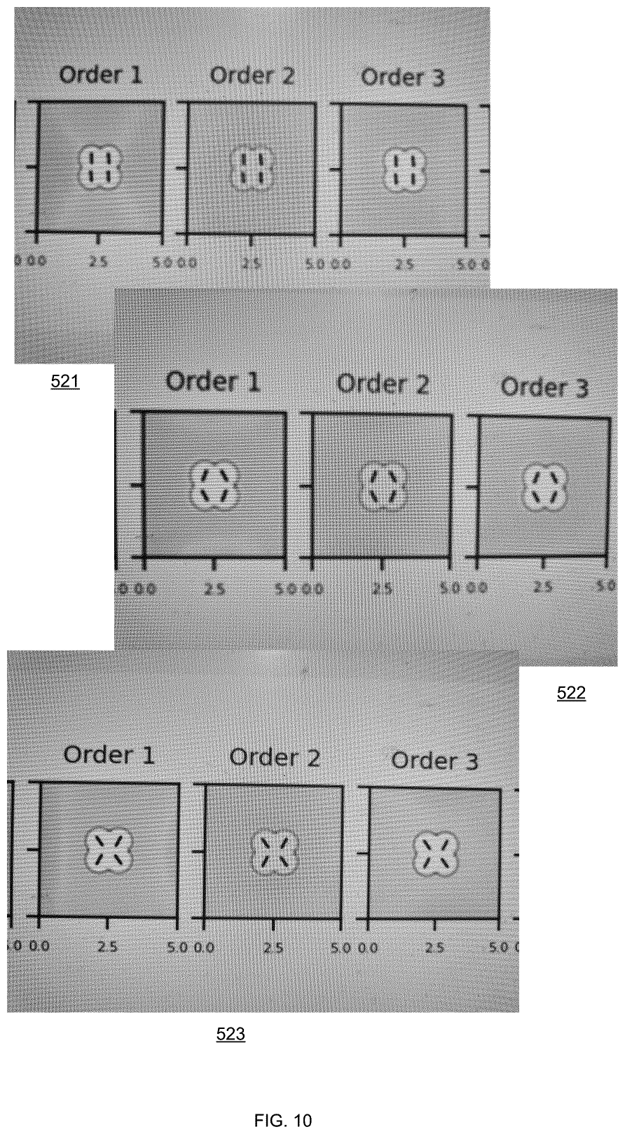

FIG. 10 illustrates examples of Order 1, Order 2, and Order 3 pressure patterns 521, 522 and 523—of a drone that includes two pairs of counter rotating rotors.

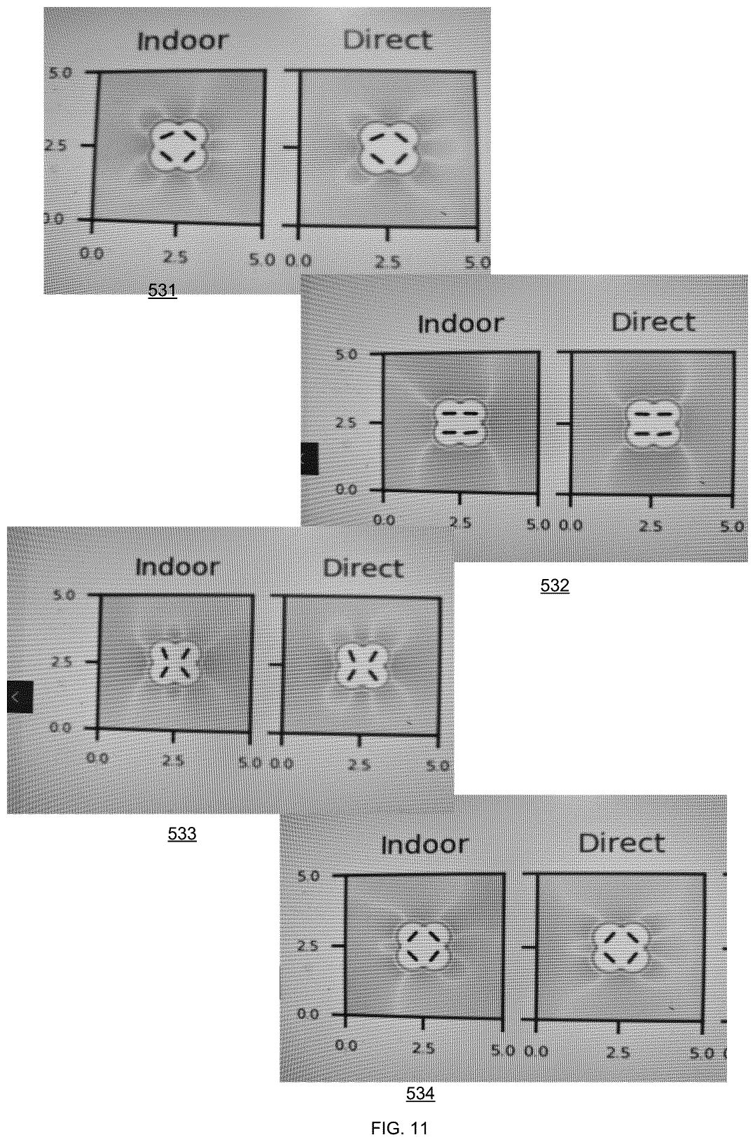

FIG. 11 illustrates examples of Indoor and Direct pressure patterns 531, 532, 533, and 534—of a drone that includes a top right motors having an incremental phase different in relation to the other three rotors of the drone.

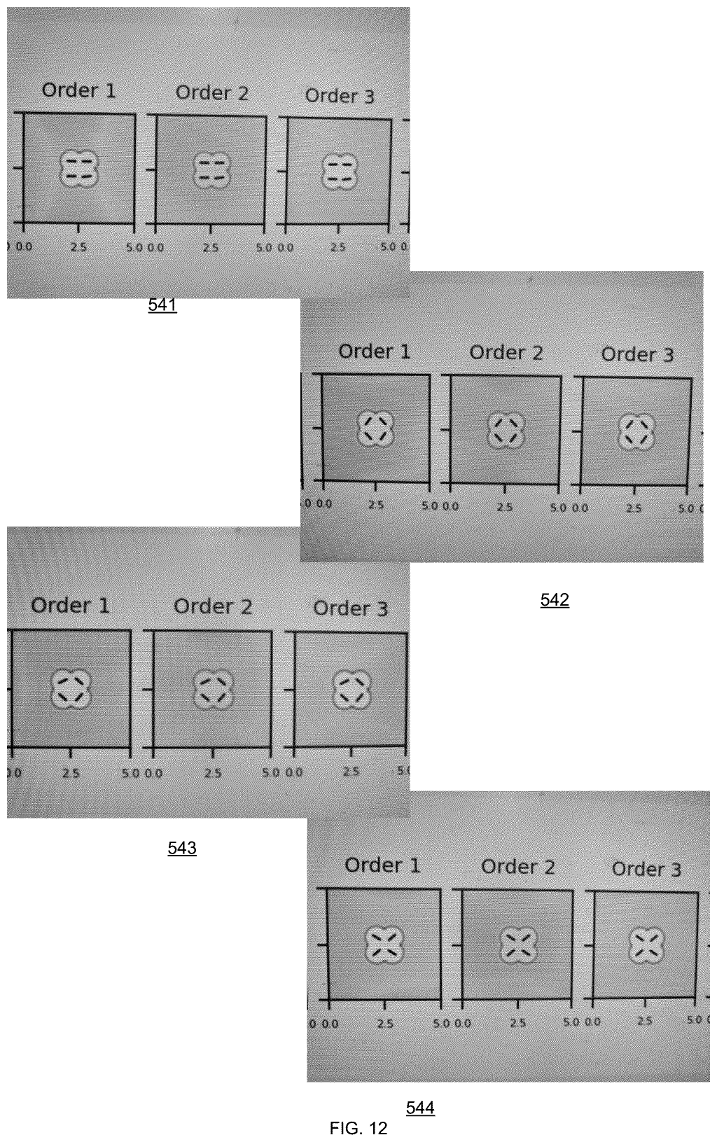

FIG. 12 illustrates examples of Order 1, Order 2, and Order 3 pressure patterns 541, 542, 543 and 544—of a drone that includes a top right motors having an incremental phase different in relation to the other three rotors of the drone.

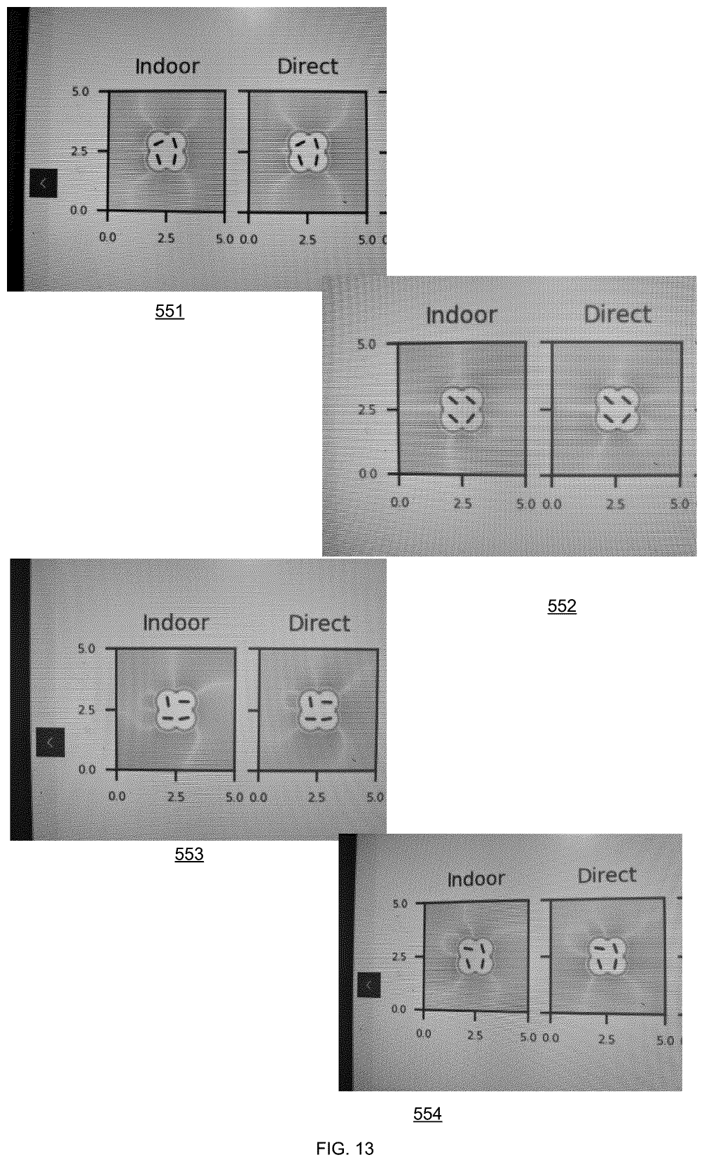

FIG. 13 illustrates examples of Indoor and Direct pressure patterns 551, 552, 553, and 554—of a drone that includes a top right motors having a ninety degrees phase different in relation to the other three rotors of the drone.

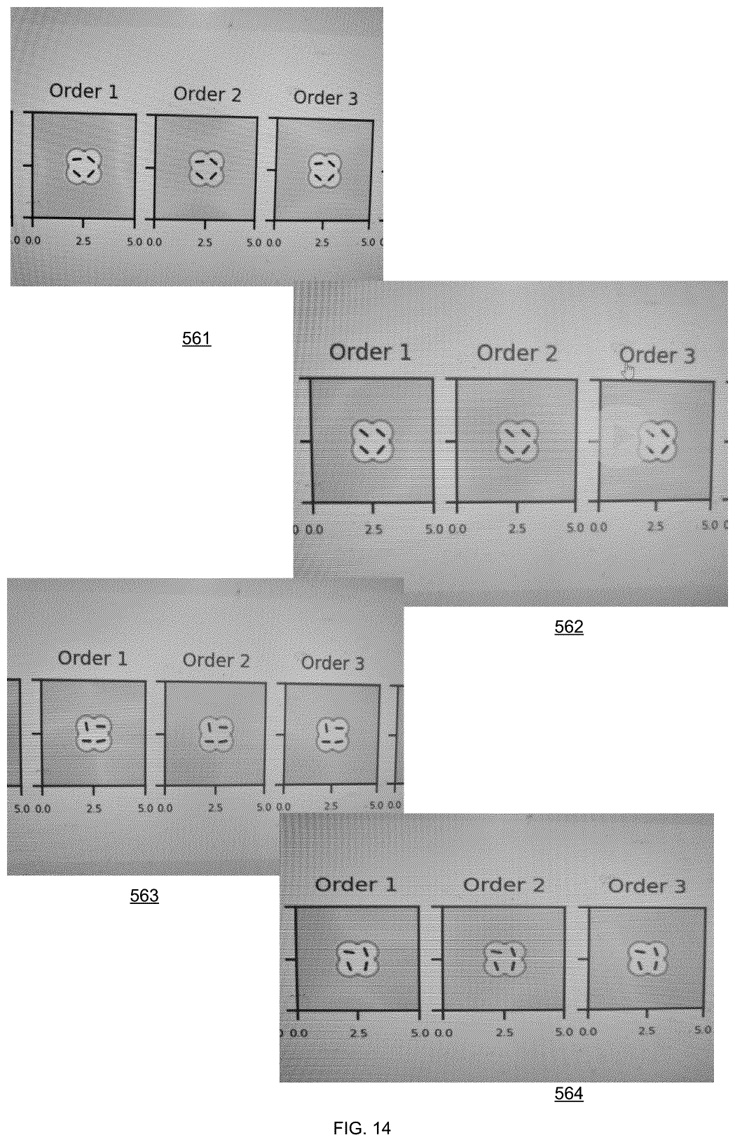

FIG. 14 illustrates examples of Order 1, Order 2, and Order 3 pressure patterns 561, 562, 563 and 564—of a drone that includes a top right motors having a ninety degrees phase different in relation to the other three rotors of the drone.

FIG. 14 illustrates examples of Order 4, Order 5, and Order 6 pressure patterns 571, 572, 573 and 574—of a drone that includes a top right motors having a ninety degrees phase different in relation to the other three rotors of the drone.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

We claim:

1. A method for localization of a drone within a building, the method comprising:
detecting, by an acoustic detection unit of the drone, sounds generated by a propulsion unit of the drone while the drone is located within the building; and
determining, by a processing unit of the drone, the location of the drone within the building, based on the sounds and on building acoustic information regarding sounds detected at different portions of the building.

2. The method according to claim 1, comprising generating at least a part of the building acoustic information by the processing unit of the drone.

3. The method according to claim 1, comprising receiving at least a part of the building acoustic information.

4. The method according to claim 1, wherein the detecting comprises detecting sounds that are generated by the propulsion unit within a blade pass frequency (BPF).

5. The method according to claim 4, wherein the determining of the location of the drone comprises applying a low power consuming location determining process.

6. The method according to claim 4, wherein the low power consuming location determination process ignores sounds outside the BPF.

7. The method according to claim 4, wherein the low power consuming location determining process is based on the building acoustic information, the building acoustic information was generated using simulations.

8. The method according to claim 7, wherein the simulations model sounds directly detected by an acoustic detection unit of a simulated drone and reflected sounds reflected from a simulated indoor environment.

9. The method according to claim 4, wherein the low power consuming location determining process is based on the building acoustic information, the building acoustic information was generated using measurements.

10. The method according to claim 1, wherein the detecting comprises performing a first plurality of determining iterations for finding a third plurality of locations of the drone.

11. The method according to claim 1, wherein the propulsion unit of the drone comprises rotors.

12. The method according to claim 1, comprising shaping the sound generated by the propulsion unit of the drone.

13. The method according to claim 12, comprising changing the shaping the sound generated by the propulsion unit of the drone between a first iteration of the detecting and a second iteration of the detecting.

14. The method according to claim 13 wherein the propulsion unit of the drone comprises rotors, and wherein the changing of the shaping comprises changing a phase relationship between the rotors.

15. The method according to claim 12, comprising changing the shaping the sound generated by the propulsion unit of the drone between different iterations of the detecting.

16. The method according to claim 15, wherein the changing occurs while the drone is stationary.

17. The method according to claim 15, wherein the changing occurs while the drone propagates within the building.

18. The method according to claim 15, wherein the changing stops when the drone successfully completes the determining the location of the drone.

19. The method according to claim 12, wherein the detecting comprises detecting sounds that are generated by the propulsion unit within a blade pass frequency (BPF).

20. A non-transitory computer readable medium that stores instructions that one executed by a drone causes the drone to:
detect, by an acoustic detection unit of the drone, sounds generated by a propulsion unit of the drone while the drone is located within the building; and
determine, by a processing unit of the drone, the location of the drone within the building, based on the sounds and on building acoustic information regarding sounds detected at different portions of the building.
